(19) United States
(12) Patent Application Publication
(10) Pub. No.: US 2022/0018315 A1
(43) Pub. Date: Jan. 20, 2022

(54) ROTARY CARBURETOR

(71) Applicant: ZAMA JAPAN CO. LTD., Iwate (JP)

(72) Inventors: Daisuke Suzuki, Iwate (JP); Naoya Wada, Iwate (JP)

(21) Appl. No.: 17/377,291

(22) Filed: Jul. 15, 2021

(30) Foreign Application Priority Data
Jul. 15, 2020 (JP) 2020-121728
Feb. 2, 2021 (JP) 2021-015346

(51) Int. Cl. F02M 9/08

(52) U.S. Cl. CPC F02M 9/085

(57) ABSTRACT

Disclosed is an improved rotary throttle valve carburetor with a simple structure and that can be adjusted easily, without replacing parts. The improved rotary throttle valve carburetor includes: a throttle valve having a throttle hole; a metering needle disposed perpendicularly to an air intake passage; a fuel nozzle; and a starting mechanism comprising a throttle valve lever, an operating cam, and an adjusting screw. The throttle valve lever is coupled to the rotary throttle valve and is configured to rotate the throttle valve into a first state with increased airflow for cold starting. The operating cam is configured to push the throttle valve lever upward and hold the throttle valve lever in the first state using an engaging protrusion. The adjusting screw is configured to adjust a depth of the metering needle being inserted into the throttle hole by adjusting a position of the throttle valve lever.

### CROSS-REFERENCE TO RELATED APPLICATION

The subject application claims the benefit of Japanese Patent Application No. 2021-015346, filed Feb. 2, 2021, and Japanese Patent Application No. 2020-121728, filed Jul. 15, 2020, both of which are incorporated herein by reference in their entireties.

### TECHNICAL FIELD

The disclosure relates generally to a rotary carburetor. Specifically, and not by way of limitation, the disclosure relates to a rotary throttle valve carburetor with a cam mechanism to move the throttle valve in the valve axial direction.

### BACKGROUND

Rotary throttle valve carburetors equipped with cam mechanisms for moving the throttle valve in the valve axial direction are widely used as devices for supplying vaporized fuel to engines such as portable equipment for work in the agriculture and forestry industries, in small vehicles, and the like.

In a rotary throttle valve carburetor, a throttle valve of a circular column shape that has a throttle valve bore and a metering needle is disposed perpendicularly to an air intake passage of the carburetor main unit. The throttle valve is moved in the valve axial direction while rotating in response to an accelerator operation to control the airflow rate while changing the degree of overlap of the throttle valve bore with the air intake passage, and also to control the fuel flow rate through changing the depth of insertion of the metering needle into the fuel nozzle.

However, when starting an engine, the engine will be cold and thereby requiring a richer mixture than when the engine is warm. Thus, in rotary throttle valve carburetors that are single fuel systems, a starting mechanism is provided such that the depth of insertion of the metering needle into the fuel nozzle will be shallower than when idling. This increases the area of opening of the fuel injection hole and thereby increasing the amount of fuel.

Additionally, a known a starting mechanism includes a throttle valve lever secured to the throttle valve that is pressed upward by a manual cam and held in an upward position at the start of the engine. This example is discussed in Japanese Unexamined Utility Model Registration Application Publication H6-83943, Japanese Unexamined Utility Model Registration Application Publication H6-67841, and Japanese Unexamined Patent Application Publication H10-131808, Japanese Unexamined Patent Application Publication 2000-161142.

However, in conventional rotary throttle valve carburetors disclosed in the publications listed above, the cam for pushing the throttle valve lever upward is unchanging, and the upward position of the throttle valve lever is stationary when the engine is cold.

Given this, the performance of conventional rotary throttle valve carburetors degrades due to extended use. The starting performance is worse than in the initial state due to the effects of gasoline and the like. Additionally, there is a problem in that the combination of the throttle valve lever and the cam may have difficulty starting the engine or failing entirely to start the engine.

Moreover, adjusting the combination of the throttle valve lever and the cam for the state of each individual engine would require component configurations customized for each engine. This makes it necessary to stock, in advance, components such as multiple different types of cams. Additionally, the control and assembly of extra components would be laborious and economically burdensome.

Because there are different fuel flow rates at starting due to cumulative tolerances in the components such as the cam, the throttle valve lever, and the like, there will also be cases where an excessive amount of time will be required to adjust the rate of flow at the time of shipping and cases where the performance is unsatisfactory.

In view of this, Japanese Unexamined Patent Application Publication 2008-31858 discusses a rotary throttle valve carburetor 100 that can be adjusted without requiring replacement of components, see FIGS. 1A, 1B. Carburetor 100 has a starting mechanism for starting an engine (not shown) by pushing upward, through a manually operated cam 2a, a throttle valve lever 1a to a rotational position for starting. When starting cold, throttle valve lever 1a is in an upward position. This places throttle valve 3a in a state that has an increased airflow. The starting mechanism includes the manually operated cam 2a and an adjusting screw 5a having a tip end that makes contact with the manually operated cam 2a by screwing adjusting screw 5a into a threaded hole 4a having an axis that is parallel with the center axis of throttle valve 3a.

Adjusting screw 5a can be turned to adjust the position to which the throttle valve lever 1a is pressed upward (which is at the rotational position for starting) through the manually operated cam 2a and through adjusting the length of protrusion from the throttle valve lever 1a. Even if the starting performance is reduced as comparted to the initial state (because of degradation due to extended use of a rotary valve carburetor with such a stating mechanism, or the effects of gasoline, or the like), the engine can be started by placing the throttle valve in a state that increases the airflow, which can be done by pressing the throttle valve lever upward through the manually operated cam when starting cold, and maintaining the throttle valve lever in the upward position.

However, in a conventional rotary throttle valve carburetor with a starting mechanism, the pushed-up position of the throttle valve lever 1a can be adjusted. For example, as disclosed in FIGS. 1A-1B, the cam face of the operating cam 2a (actuatable cam) has an inclined face on the tip end that undergoes reciprocating motion in a linear direction. When starting cold, the tip end is held up at a position that pushes the throttle valve lever 1a upward and requires a separate holding mechanism for holding at the position of adjusting screw 5a (which is at the tip end of operating cam 2a). The holding mechanism for holding the pushed-up state is structured from rotary cam 6a that secures operating cam 2a to the axis of throttle valve lever 1a when cold. The holding mechanism includes cam screw 7a that engages with a cam face formed on the peripheral surface of rotary cam 6a (at the tip end of the operating cam 2a).

Because of this, the structure of carburetor 100 is complex and requires more components, which leads to increased number of manufacturing steps, increased expense, and problems such as increased manufacturing variabilities and cumulative tolerances.

Moreover, the conventional rotary throttle valve carburetor with the manually operated cam 2a that undergoes reciprocating motion in a linear direction has a risk of causing engine vibration, and therefore not suitable for use in carburetors that have different amounts of exhaust, having different advance angles, despite being identical operating cams. This is due to the design of the conventional cam. The cam of conventional rotary throttle valve reciprocates a linear direction to adjust to the pushed-up position using adjusting screw 5a that screws together with the throttle valve lever 1a in the rotary throttle valve carburetor, which has a starting mechanism that enables adjustment of the pushed-up position of the throttle valve lever 1a. Rotary cam 6a is engaged by lever 1a. Rotary cam 6a is secured to the valve rod of throttle valve lever 1a and holds the operating cam 2a so that the throttle valve lever 1a will be in the cold position. Additionally, with rotary cam 6a holding operating cam 2a so that throttle valve lever 1a is in the cold position, problems can occur in that the state of the settings between the cold position and the throttle being fully open are shortened by an amount commensurate with the rotary cam 6a. This makes conventional rotary throttle valve carburetor difficult for use in a small general-use engine.

### SUMMARY

One of the objectives of the present disclosure is to provide a rotary throttle valve carburetor with the following advantages: minimum number of components; small foot print; fuel flow rate can be adjusted easily when starting despite variability of cumulative tolerances of components and adjustments are possible without requiring replacement of parts; carburetor settings not prone to engine vibrations; long term durability despite extended use and effects of gasoline; the same operating cam can be used in different carburetors where the amounts of exhaust are different, having different advance angles; and the state of settings between the cold position and full opening of the throttle is not shortened.

The disclosed rotary throttle valve carburetor (hereinafter the “disclosed carburetor”) includes a circular column-shaped throttle valve having a throttle hole and a metering needle, which is disposed perpendicularly to an air intake passage of a carburetor main unit. The metering needle can be disposed within the fuel nozzle that is connected to a fixed fuel chamber.

The disclosed carburetor includes a throttle hole that is open to the fixed fuel chamber and into which the metering needle is inserted. The airflow and fuel flow rates are controlled through the movement of the throttle valve. In response to an accelerator operation, the throttle valve is configured to rotate about its axis. In the cold starting mode (position), the throttle valve is placed into a state with increased airflow by moving the operating cam to push the throttle valve lever upward and locking it in the cold-start position. The operating cam includes a tapered distal end configured to push the throttle valve upward until it is locked into position by an engaging portion.

The throttle valve lever can include a hole (e.g., slot) configured to receive an adjusting screw. The tip of the adjusting screw is configured to make contact with a surface of the tapered distal end of the operating cam. When both are in contact with each other, the surface of the tapered distal end pushes the adjusting screw upward, which in turn pushes the throttle valve lever, as the operating cam is actuated in the direction away the throttle valve lever. Once the adjusting pin is advanced over the engaging portion (raised portion) of the distal end, the adjusting screw is locked into place while the operating cam is being biased toward the throttle valve by a biasing member (e.g., a spring). The adjusting screw and/or the hole can be parallel to the axis of the throttle valve. The length of protrusion of the adjusting screw can be adjusted, which determines the position to which the throttle valve lever is pushed up.

The operating cam can be manually actuated in a linear direction that is perpendicular to the axis of the throttle valve. The operating cam is biased in a direction by a biasing member. The base end side of an engaging protrusion formed on the tip end of the top face of the operating cam has a cross-section of a sideways-P shape. The tip end of the adjusting screw that screws into the throttle valve, where after the operating cam being moved in the direction of the tip end and the adjusting screw of the throttle valve lever that is at the rotational position for cold starting, is pushed up by the engaging protrusion to contact the engaging portion to hold the throttle valve lever at a prescribed height position. The throttle valve lever is rotated to release the engagement with the adjusting screw that is held on the engaging portion, and the operating cam is returned to the original non-actuated state by the biasing member.

The above operating cam of the disclosed carburetor enables adjustments to be made easily and quickly, without removing components. The throttle valve can be placed in a pushed-up position by manually operating the cam and turning the adjusting screw from the top surface side of the throttle valve lever.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIGS. 1A and 1B illustrate a conventional rotary throttle valve.

FIG. 2 illustrates a perspective view of a rotary throttle valve in accordance with some embodiments of the present disclosure.

FIG. 3 illustrates a partial cross-sectional view of the rotary throttle valve of FIG. 2 in accordance with some embodiments of the present disclosure.

FIG. 4 illustrates a partially exploded view of the rotary throttle valve of FIG. 2 in accordance with some embodiments of the present disclosure.

FIG. 5A illustrates a starting mechanism of the rotary throttle valve of FIG. 2 in a non-actuated state in accordance with some embodiments of the present disclosure.

FIG. 5B illustrates a starting mechanism of the rotary throttle valve of FIG. 2 in an actuated state in accordance with some embodiments of the present disclosure.

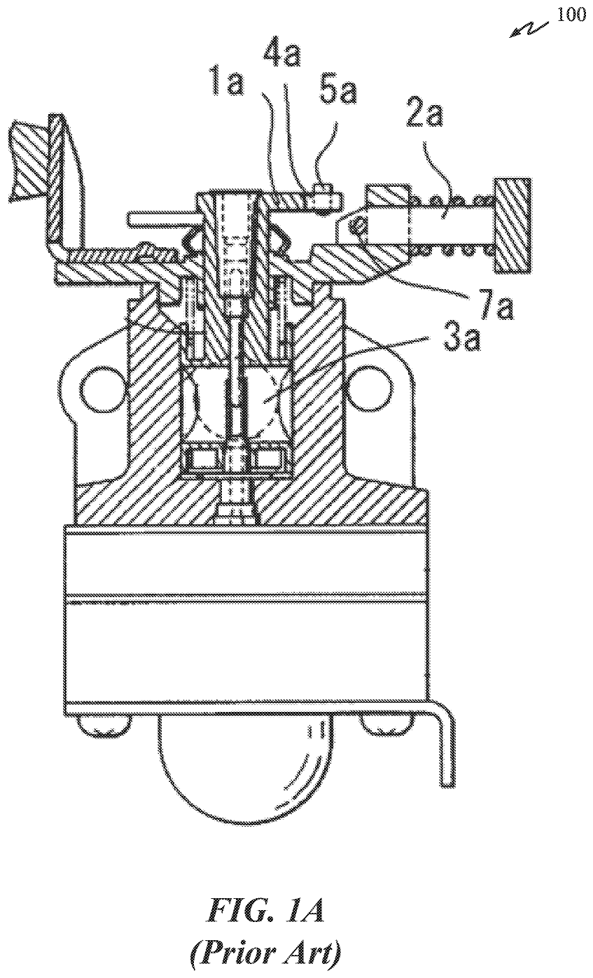

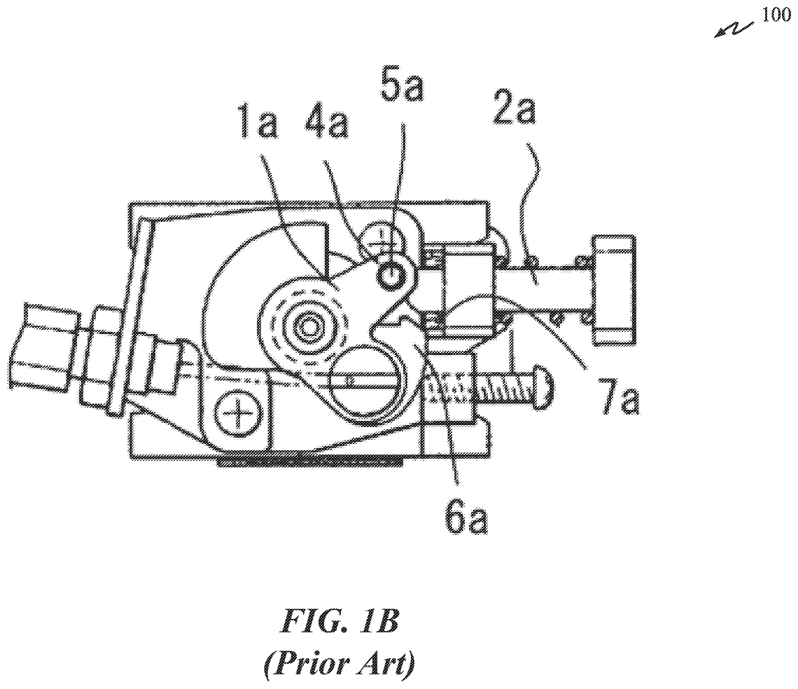

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The disclosed throttle valve carburetor is equipped with a starting mechanism for starting an engine by placing the throttle valve into a state that has increased airflow. This is done by placing throttle valve lever in an upward position via the manually operated cam. The adjustment can be done easily and without requiring replacing parts.

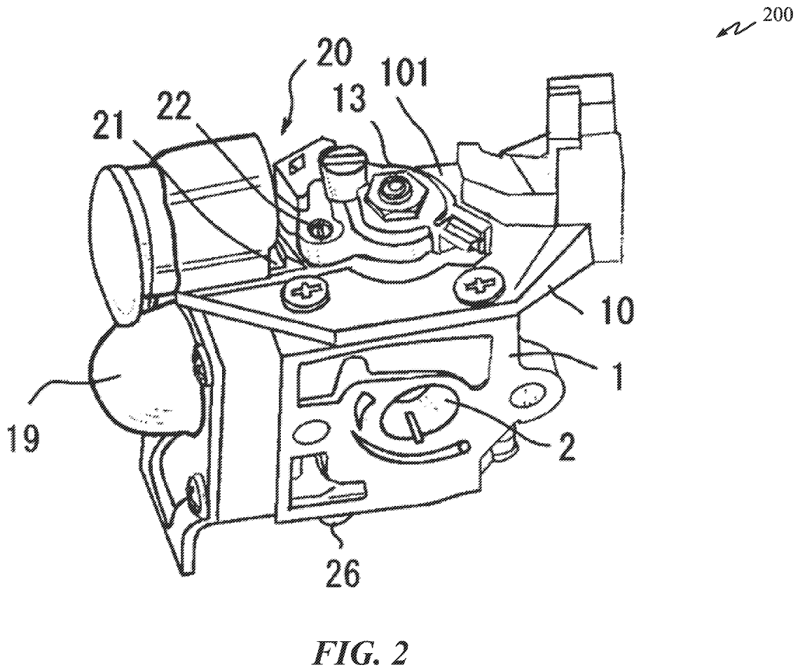

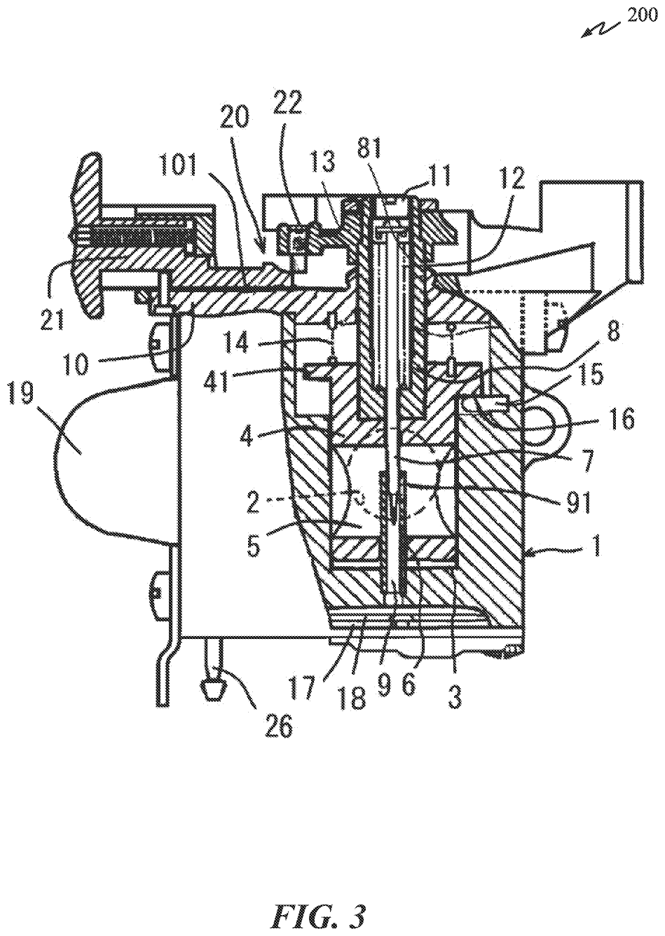

FIGS. 2, 3, 4, 5A and 5B illustrate a throttle valve carburetor 200 in accordance with some embodiments of the present disclosure. Carburetor 200 includes main unit (e.g., body) 1 with an air intake passage 2 that passes therethrough lengthwise. Carburetor 200 also includes a valve bore 3 (see FIG. 3), perpendicular thereto, with an enclosed bottom end. Carburetor 200 includes a circular column-shaped throttle valve 4 fitted into the valve bore 3 such that throttle valve 4 can rotate axially.

Moreover, throttle valve 4 has a throttle hole 5 that is perpendicular to center axis of the throttle valve. Throttle hole 5 has generally the same diameter as the air intake passage 2 and can be positioned on the center axis thereof. Carburetor 200 also includes nozzle insertion hole 6, metering needle 7, and valve rod 8.

Nozzle insertion hole 6 is provided through the enclosed bottom of valve bore 3. Fuel nozzle 9 is inserted through insertion hole 6 where valve rod 8 is secured to the end portion of throttle valve 4, which is positioned on the open end side of valve bore 3. Valve rod 8 passes through cover body 10, which covers the open end face at the top of valve bore 3. Valve rod 8 can extend outside of the carburetor main unit 1. Metering needle 7 can be pressed by pressing spring 12 against adjusting screw 11, which is screwed into a screw hole 81 of the valve rod 8. Adjusting screw 11 can be adjusted to change the length of protrusion of metering needle 7 into the throttle hole 5. In other words, adjusting screw 11 can adjust the depth of insertion of metering needle 7 into the fuel nozzle 9. In some embodiments, adjusting screw 11 can adjust the depth of insertion of metering needle 7 into the fuel nozzle 9 during idling.

In some embodiments, throttle valve lever 13, which is rotated by acceleration operation of a driver, is secured to an end of valve rod 8 and valve closing spring 14. Valve closing spring can be a torsion coil spring. Valve closing spring 14 can be secured to throttle valve 4 and cover body 10 and can be disposed around valve rod 8.

Flange 41 is provided on an end portion of valve rod 8 at one side of throttle valve 4. Cam 16 is formed on the bottom face at the opposite side of throttle valve 4. Cam 16 can be in contact with pin 15, which protrudes from carburetor main unit 1. In this way, when throttle valve lever 13 is rotated by an acceleration operation, throttle valve 4 rotates integrally therewith to change the degree of overlap with air intake passage 2 of throttle hole 5. This controls the amount of air that is fed to the engine.

Simultaneously, throttle valve 4 rotates axially to cam 16 (which is in contact with pin 15) to change the depth of insertion of metering needle 7 into fuel nozzle 9. This thereby controls the rate of flow of fuel that is drawn in from fuel injection hole 91.

Fixed fuel chamber 17 can be identical to that of a well-known membrane-type carburetor, which is partitioned from atmosphere by a diaphragm 18. In one aspect, diaphragm 18 can be located at the end face of carburetor main unit 1 that is opposite from the cover body 10, with the air intake passage 2 therebetween. Fuel from fixed fuel chamber 17 is sent to fuel nozzle 9 and is drawn into the interior of throttle hole 5 from fuel injection hole 91. The opening area of fuel injection hole 91 can be restricted by metering needle 7. In some embodiments, throttle valve carburetor 200 can be equipped with a manual primary pump 19, throttle valve 4, fixed fuel chamber 17, and diaphragm 18.

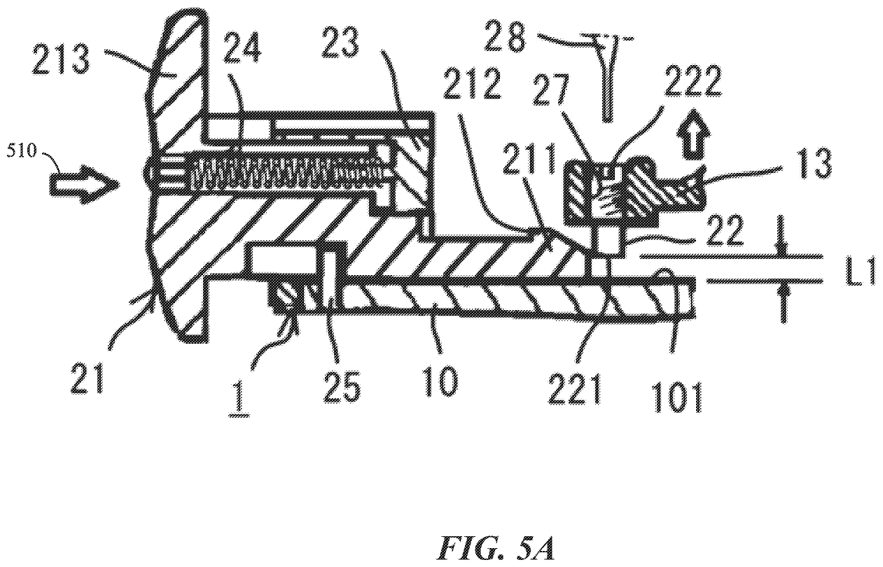

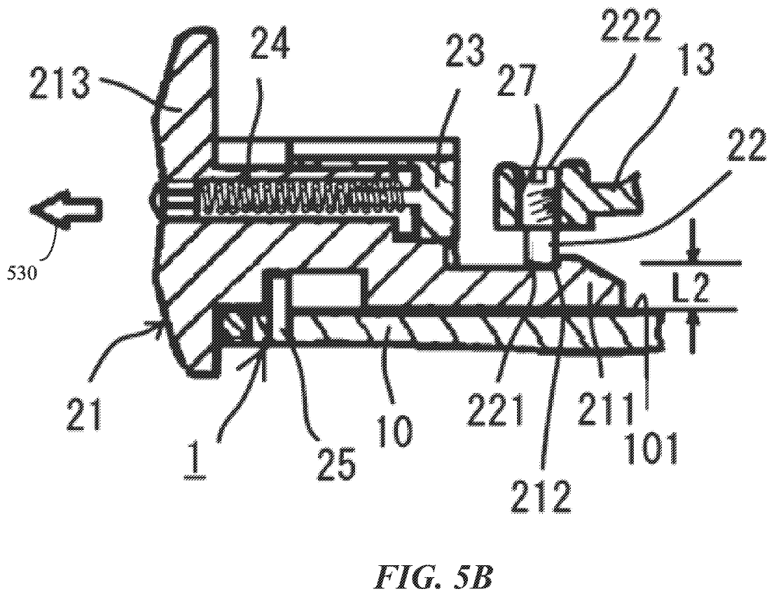

In some embodiments, starting mechanism 20 of throttle valve carburetor 200 can be disposed on top face 101 of cover body 10. Starting mechanism 20, as depicted in FIG. 5A, includes throttle valve lever 13 disposed on the end of valve rod 8 (See FIGS. 2, 3, 5A, and 5B. As shown in FIG. 5A, the prescribed distance L1 is measured from top face 101 of cover body 10 in carburetor main unit 1 to the tip of adjustment screw 22 (e.g., pin). A manually operated cam 21 that is disposed at a prescribed position on top face 101 of cover body 10. Cam 21 is biased in a direction 510 toward throttle valve lever 13 by spring 24. Cam 21 can be linearly actuated manually by pulling cam 21 in a direction opposite of direction 510 until engaging portion (engaging protrusion) 212 mate with a side surface of adjusting screw 22. During cold starting, throttle valve lever 13 is held at a rotational position for starting, determined in advance, by (for example) an accelerator wire, or the like (not shown). In some embodiments, the biasing force of spring 24 can be reversed from a pulling force to a pushing force. In this way, the manual actuation of cam 21 is reversed by pushing cam 21 toward throttle valve 24 instead of pulling cam 21 away from throttle valve 24.

Referring to FIG. 5B, throttle valve 13 is lifted to a position to prescribed distance L2 by a tapered distal end of engaging member 211. L2 can be measured from the top face 101 of the cover body 10 to the tip of adjusting screw 22. Engaging member 211 has a tapered/slanted surface configured to lift throttle valve 13 as cam 21 is moved toward throttle valve 13 (direction 510). In the lifted position (L2), throttle valve lever 13 lessen the insertion depth of metering needle 7 into the fuel nozzle 9. This thereby increases the area of opening of the fuel injection hole 91 and increases the amount of fuel injected into the engine. In this way, the engine is able to start easily from the cold state.

Starting mechanism 20 includes operating cam 21 and an adjusting screw 22 that screws into a screw hole 27, which has an axis parallel to the center axis of the throttle valve 4. Hole 27 is a pass through hole such that adjusting screw 22 can engage engaging portion 212 of engaging member 211. Engaging portion 212 can be a raised portion (lip) configured to stop cam 21 from sliding back in the direction 505 (FIG. 5A) due to the pushing force of spring 24.

In some embodiments, adjusting screw 22 can be positioned substantially on the center axis while throttle valve 13 is in the starting position. Holding member 23 can be attached to cover body 10. When the engine temperature is not cold, such as room temperature, and when the starting mechanism 20 is not used, operating cam 21 is biased in the direction of the arrow 530 by a biasing member 24.

Biasing member 24 can be a compression spring provided between operating cam 21 and holding member 23. Engaging member 211 is formed on the distal end and is configured to hold throttle valve lever 13 in a raised position by securing and supporting adjusting screw 22. Also provided is a stop pin 25 configured to stop cam 21 from moving too far in the direction 510 (toward throttle valve 13). Stop pin 25 is located at a position on cover body 10 such that when cam 21 is stopped, adjusting screw 22 would be lifted over the tapered surface of engaging portion 211 and resting at the position illustrated in FIG. 5B.

FIG. 5B illustrates a cold starting state in accordance with some embodiments. When pulling interface portion 213 of operating cam 21 in the direction of arrow 530, against the biasing force of the biasing member 24, tip end 221 of the adjusting screw 22 moves past engaging member 211 to engage with the engaging portion 212. This causes throttle valve lever 13 to be pushed up to the cold position, as shown. The cold position has a prescribed distance L2, which is longer than the distance L1. At the prescribed distance L2, the insertion depth of metering needle 7 into the fuel nozzle is less than the insertion depth of metering needle 7 while the engine is idling (throttle valve lever 13 in the L1 position as shown in FIG. 5A). With less insertion depth, the opening area of the fuel injection hole is increased. This increases the amount of fuel and thereby facilitates the start of the engine when cold.

Throttle valve carburetor 200 enables the adjustment of the push-up position of throttle valve lever 13 through the manually operated cam 21, which adjusts the height of throttle valve lever 13 with respect to cover body 10. The height adjustment (i.e., L1 to L2 or L2 to L1) is accomplished by rotating throttle valve lever 13 such that adjusting screw 22 engages with or disengages from engaging portion 212. This layout enables starting mechanism 20 to adjust for cold starting easily and reliably, without adding or replacing components, at the time of manufacturing. In this way, carburetor 200 can be adjusted and/or readjusted easily by changing the position of adjusting screw 11 and/or 22 once the starting performance of the engine has been reduced (as compared to the initial state of a brand new engine). In other words, once the engine's performance degraded through extended use and/or due to the damaging effects of gasoline, carburetor 200 can be easily tuned. In some embodiments, carburetor 200 can be tuned by adjusting at least adjusting screw 11 and/or 22, which controls the insertion depth of metering needle 7 while throttle valve 4 is in either the L1 or L2 state.

In some embodiments, adjusting screw 11 and/or 22 can be adjusted by a tool 28, such as a screwdriver. For example, adjusting screw 22 at the top surface throttle valve lever 13 can be adjusted to modify the push-up position of throttle valve lever 13 by adjusting the length of adjusting screw 22 extending beyond hole 27. In this way, carburetor 200 can be easily tuned.

In some embodiments, engaging member 211 (which forms the engaging portion 212) directly limits the movement of operating cam 21 in the reciprocating motion direction during cold starting. Thus, there is no need to provide a separate mechanism for this purpose. As a result, there is no increase in the number of components or assembly, and no variability in the cumulative tolerance due to extra component(s). Additionally, the motion of operating cam 21 and throttle valve lever 13 are constrained by each other and by at least (1) biasing member 24 and/or (2) pin 25. This enables the motion of each component (i.e., throttle valve lever 13 and cam 21) to be accurately controlled. In this way, at the cold position, there is little danger of throttle valve lever 21 becoming disengaged (e.g., move from L2 to L1) due to the vibration of the engine, or the like.

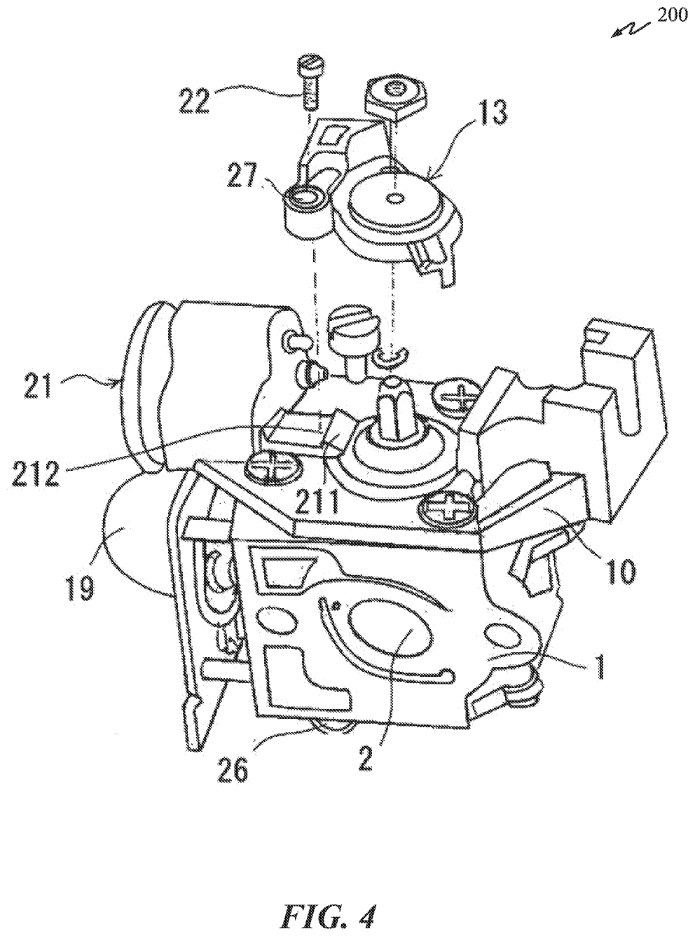

Furthermore, in some embodiments, adjusting screw 22 is configured to freely to move by the amount of its width after the engine has been started through actuation of the starting device 20. Throttle valve lever 13 can be rotated through the speed of the engine increasing through an accelerator operation, so that adjusting screw 22 rotates from the starting position to come out from engaging portion 212 of the operating cam 21. This releases the engagement between operating cam 21 and adjusting screw 22. In this scenario, operating cam 21 is pushed against stop pin 25 (in the direction toward the outside) by biasing member 24. In this way, starting device 20 (FIG. 4) can be returned reliably to its original state when not actuated.

In some embodiments, operating cam 21 and throttle valve lever 13 mesh directly with each other in the axial direction, so that the area or the range of rotation required for the cold position will be small when compared to the conventional cold holding mechanism that engages in the horizontal direction. The design of carburetor 200 enables the state of settings between the cold position and the position with the throttle fully opened will be long. Furthermore, the same operating cam of carburetor 200 can be used in carburetors with different amounts of exhaust and advance angles.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A rotary throttle valve carburetor comprising:
a throttle valve having a throttle hole, the throttle valve is configured to rotate about an axis to control an airflow and fuel flow rate;
a metering needle disposed perpendicularly to an air intake passage of a carburetor main unit, wherein the metering needle is inserted into the throttle hole;
a fuel nozzle connected to a fixed fuel chamber, wherein the fixed fuel chamber is in fluidic communication with to the throttle hole;
a starting mechanism comprising a throttle valve lever, an operating cam, and an adjusting screw, wherein the throttle valve lever is coupled to the rotary throttle valve and is configured to rotate the throttle valve into a first state with increased airflow for cold starting, wherein the operating cam is configured to push the throttle valve lever upward and hold the throttle valve lever in the first state using an engaging protrusion, wherein adjusting screw is configured to adjust a depth of the metering needle being inserted into the throttle hole by adjusting a position of the throttle valve lever, wherein the operating cam is configured to actuate in linear motion and is constantly biased in a direction toward the throttle valve lever by a biasing member, wherein the throttle valve lever configured to rotate to release the throttle valve lever from the first state to a second state where the operating cam is actuated away from the throttle valve lever to move the throttle valve and the metering needle toward the fuel nozzle.

2. The rotary throttle valve carburetor of claim 1, wherein throttle valve comprises a circular column-shaped cylinder.

3. The rotary throttle valve carburetor of claim 1, wherein the engaging protrusion comprises a raised portion having a tapered distal end.

4. The rotary throttle valve carburetor of claim 1, wherein the throttle valve lever comprises a slot and a second adjustment screw disposed within the slot, wherein the second adjustment screw is configured to engage the engaging protrusion when the operating cam is in the first state.

5. The rotary throttle valve carburetor of claim 4, wherein the second adjustment screw is configured to rotate away from the engaging protrusion as the throttle valve lever rotates to release the throttle valve lever from the first state into the second state.

6. The rotary throttle valve carburetor of claim 1, further comprising a stop pin configured to stop operating cam at a predetermined position.

7. The rotary throttle valve carburetor of claim 6, wherein the stop pin is configured to stop the operating cam from moving toward the throttle valve lever once the adjustment screw engages the engaging protrusion.

8. The rotary throttle valve carburetor of claim 1, wherein the throttle valve comprises a circular column-shaped throttle valve.

9. A rotary throttle valve carburetor comprising:
a cylindrical throttle valve having a throttle hole, the throttle valve rotatably disposed within a main body of a carburetor;
a metering needle disposed perpendicularly to an air intake passage of the main body of the carburetor, wherein the metering needle is inserted into the throttle hole of the throttle valve and into a fuel injection hole of a fuel nozzle; and
a throttle valve lever coupled to an actuable cam, wherein the actuable cam is configured to actuate and push the throttle valve lever in a direction away from throttle valve and to hold the throttle valve lever in a first state, wherein metering needle is retracted toward the throttle valve lever in the first state such that the metering needle is partially retracted out of the fuel injection hole, wherein the throttle valve is configured to rotate and move throttle valve lever in a direction toward from throttle valve to a second state, wherein metering needle is moved farther into the fuel nozzle in the second state.

10. The rotary throttle valve carburetor of claim 9, wherein the actuable cam comprises a spring to continuously bias the actuable cam in a direction toward the throttle valve lever.

11. The rotary throttle valve carburetor of claim 9, wherein the throttle valve lever comprises a slot and an adjustment screw disposed within the slot, wherein the adjustment screw is configured to engage an engaging protrusion of the actuable cam in the first state.

12. The rotary throttle valve carburetor of claim 2, the throttle valve lever is farther away from the throttle valve while in the first state.

13. The rotary throttle valve carburetor of claim 9, further comprising a stop pin configured to stop actuable cam at a predetermined position.

14. The rotary throttle valve carburetor of claim 13, wherein the stop pin is configured to stop the actuable cam from moving toward the throttle valve lever once the adjustment screw engages the engaging protrusion.
